(19) United States
(12) Patent Application Publication
(10) Pub. No.: US 2009/0107415 A1
(43) Pub. Date: Apr. 30, 2009

(54) Bird Skate Amusement Device

(76) Inventor: Patricia M. Handal, South Lake Tahoe, CA (US)

Correspondence Address: BERENATO, WHITE & STAVISH, LLC, 6550 ROCK SPRING DRIVE, SUITE 240, BETHESDA, MD, 20817, US

(21) Appl. No.: 12/258,441

(22) Filed: Oct. 26, 2008

Related U.S. Application Data
(60) Provisional application No. 60/983,109, filed on Oct. 26, 2007.

(51) Int. Cl. A01K 29/00

(52) U.S. Cl. 119/707

(57) ABSTRACT

The invention is a low center of gravity animal toy. The toy is a skate type device that includes a perch mounted on a pedestal. The perch is knurled for extra grip and enables an animal, usually a large bird, to grip the skate and shuffle in skating fashion over a surface. The device includes a training bar for teaching the appropriate motion to skate. Safe and fun interactive and solo play for parrots or other animals is provided.

This application claims the benefit of Provisional Application No. 60/983,109, filed Oct. 26, 2007.

### BACKGROUND OF THE INVENTION

1. Field of the Invention

The present invention relates to a colorful rolling toy with removable training bar for use in training and amusing animals; primarily large birds. Specifically, the invention is a colorful anodized aluminum rolling toy with perch on top, 4 wheels, and a removable training bar.

2. Description of the Prior Art

Pet owners enjoy interactive contact with their pets. Owners talk to their pets, play with them, exercise together, and generally pal around for companionship purposes. Items like training devices and toys that promote safe owner/pet interaction have long been popular. Stepping into a pet store, a pet owning person is confronted with an almost endless array of toys ranging from sticks (literally) to computerized devices with web cameras, joy stick remote control, etc.

A primary concern of any pet owner is the safety and durability of the toy as well as general suitability of the toy for the pet. Not all toys suit all pets. Small pets can make great use of some items made of plastic, wood, rubber, whereas larger pets might claw, chew, and swallow the same toy in the blink of an eye. In addition, pets and owners both become bored with repetitive toy interaction over time. A preferred toy is one that creates unique interaction for the pet/owner and occasional onlooker who can likewise be entertained in the same way as is the pet and owner.

Hence, a useful toy for animals that can resist destruction from casual use by the animal and owner, and at the same time create unique interaction between the owner and pet with almost every use, would be desirable.

### SUMMARY OF THE INVENTION

The present invention is a colorful anodized aluminum rolling toy with removable training bar. The invention is comprised of all parts preferably made from 6061-TS grade aluminum or other claw and chew resistant material. When made of aluminum, a soft anodizing process is used to provide color and a smooth non-toxic surface finish to the final product. There are two colors used for each skate. The body of the skate is a flat rectangular platform. The body is drilled and tapped in the front for a training bar to be screwed in when needed. The training bar is a tubular rod with a flat rectangular finger grip that is attached to the rod with fasteners. Two holes are drilled side to side through the body for the axles. The four round wheels are preferably pressed onto the axle. The round perch is drilled and tapped and elevated on a pedestal and attached using fasteners. The surface of the round perch is knurled to minimize slippage between the grasping claw and perch surface.

This is an invention that provides a stimulating interactive toy for intelligent birds and attentive owners. After a training period using the training bars on the skates to pull the bird side by side in a skating motion, the bird will learn the proper movement to self propel in a forward rolling fashion on the skates.

Modifications in styling or materials can provide an end product with the same or similar functionality. For example, the perch could be wider or higher. The wheels could be attached differently (i.e., screwed on) or placed between longitudinally attached side rails that enable a single wide wheel at each end to be captured there between. The training bar could be merely straight without the end tab. The platform could be somewhat thinner/longer. Instead of aluminum, as already mentioned, wood or plastic could be used. Caution should be used, however, inasmuch as if a non-metal device is used with larger parrots, such a toy would likely be destroyed rapidly, and the chewed off parts could be ingested which could prove fatal.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a top and left side perspective view of the bird skate according to the present invention.

FIG. 2 is a left side view of the bird skate of FIG. 1.

FIG. 3 is a right side view of the bird skate of FIG. 1.

FIG. 4 is a front view of the bird skate of FIG. 1.

FIG. 5 is a rear view of the bird skate of FIG. 1.

FIG. 6 is a top plan view of the bird skate of FIG. 1

FIG. 7 is a bottom plan view of the bird skate of FIG. 1.

FIG. 8 is a left side view of the bird skate of FIG. 1 shown with a training draw bar attached to the front side thereof.

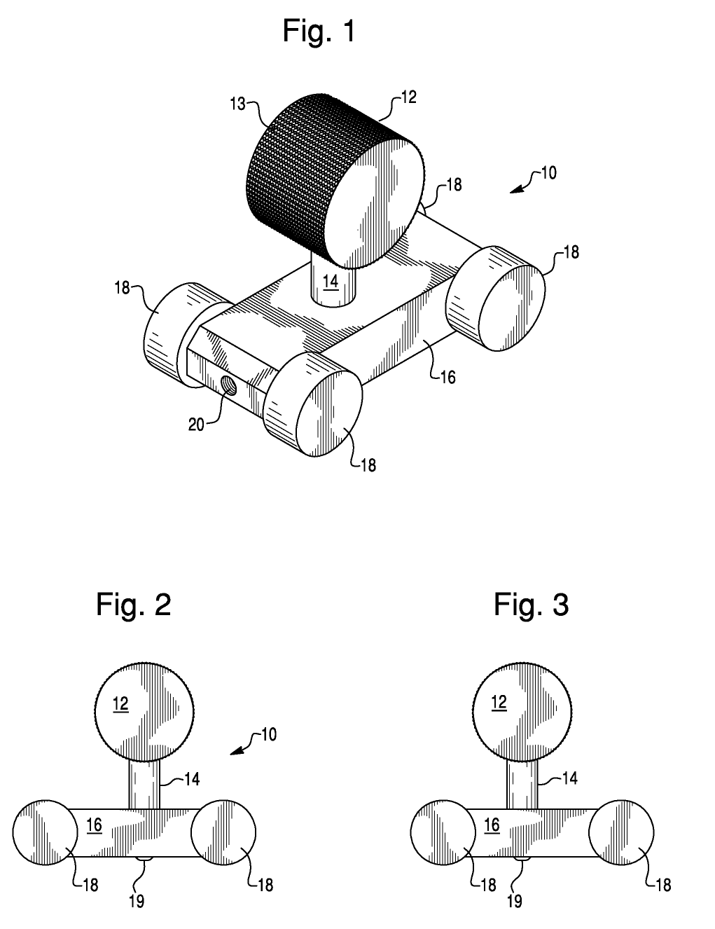

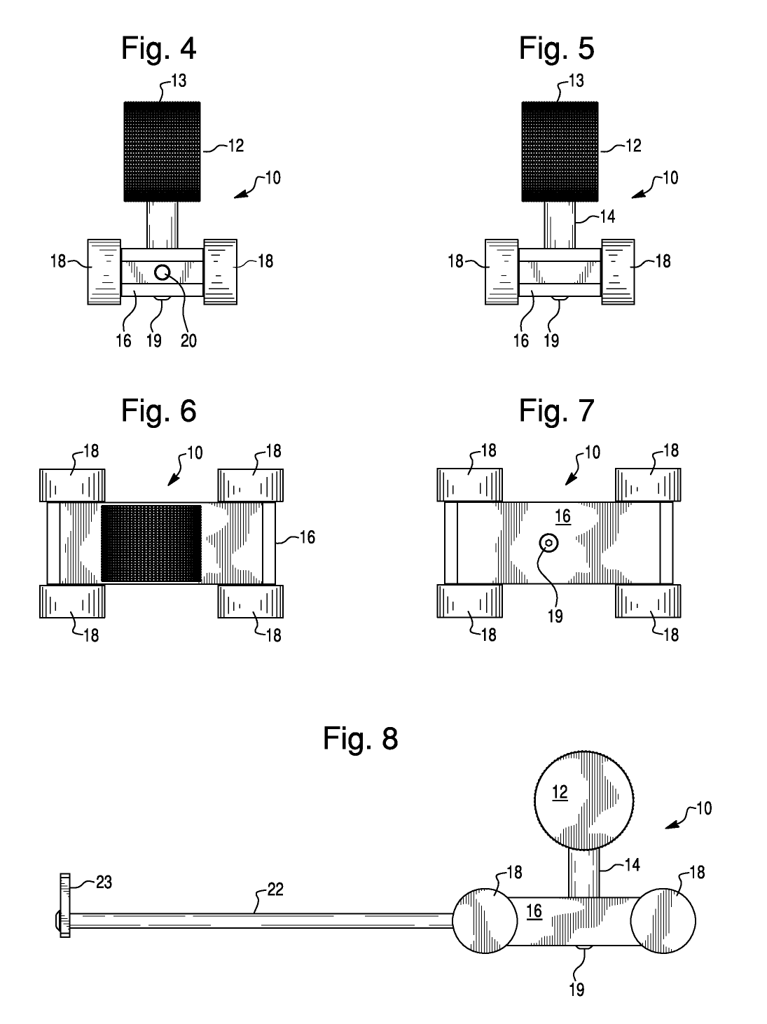

### DETAILED DESCRIPTION

With reference to the drawing figures: The skate 10 includes a platform body element 16 that is longitudinally oriented. The body 16 includes axles attached either directly to the sides of the body or, preferably, to separate axles inserted through axle accommodating holes drilled orthogonal to the longitudinal orientation of the body 16. Wheels 18 (4 shown) are respectively fastened to the axles by either pressing (friction interference fit) or through separate fasteners that allow for smooth rotation. The objective is to create a relatively stable low-slung, low center of gravity, easily rollable platform for the balance of the skate 10 elements.

The skate body 16 has an upright pedestal 14 attached thereto. This pedestal element 14 can likewise be interference press fit into a drilled hole in the skate body 16 or can be attached with a fastener 19 attached through a hole drilled entirely through the skate body 16 (as shown, see FIG. 7). On to upper end of the pedestal 14 a perch 12 with a knurled finish 13 is attached. The perch 12 can be press fit onto the end of the pedestal 14 or can be fastener equipped, i.e., a threaded dowel, so as to firmly associate the pedestal and perch. The knurling or texturing is useful in providing a relatively high grip surface for the animal (i.e., large bird) to alight onto the skate.

In order for the animal to be trained or familiarized with the skate and its operation, a training bar 22, shown equipped with a finger tab/grip 23, can be mounted to a forward end of the skate body 16 through a threaded hole 20. This bar 22 enables an owner/trainer to move the skate(s) selectively one and then the other in a skating shuffling motion to help the animal learn the necessary motion to work the skate. Once sufficient familiarity is obtained, the training bar 22 can be dismounted and the bird or other animal can move on its own.

The final product is a low center of gravity rolling platform with an upstanding perch for the bird to stand on. The detachable training bar is used initially to pull the bird on the skates and teach the bird the proper foot movements. Once learned, as noted, the training bar can be unscrewed and the bird can self propel on the skates. Many birds will also use the knurled surface of the perch to chew on and rub their beak. This helps to clean the beak and keep the shape and prevent overgrowth.

The preferred material for constructing the skate is aluminum, but other materials can be used. The requirements are that the material chosen be sufficiently resistant to destructive engagement with the animal using the skate. Metal or aluminum is preferred because of its durability in this use with large birds. The largest size skate body is in the range of 3-4 inches in length with a ¾ inch×1¼ inch cross section. Smaller size skate bodies can be in the range of 1½ to 2 inches in length with ⅜ inch×⅝ inch cross sections. Wheels can range in diameter from ⅝ to 1 inch or even larger. The perch diameter can be as small as ¾ diameter to as large as 1½ inches or so. Another feature of the relative proportions of the skate as shown and the metal selected results in ⅔ to ¾ of the total weight (2 oz. is the total weight in the smaller size to about 12 oz. in the larger size) of the skate being in the body/wheel/training bar elements of the skate. This creates a center of gravity that is low in the device, relatively near the surface being rolled upon, and provides a sense of stability and security to the bird and owner/trainer. The low center of gravity and relative heft provide stability and resistance to lifting thereby encouraging the shuffling action for skating.

The skate can be decorated (with a non-toxic variety of decals, paints, etc.) and can be used for other species of animals besides birds such as rats, hamsters, gerbils, guinea pigs, squirrels, or other pocket pets. Also, some non-psittacine birds such as raptors, hawks, eagles, owls, falcons) may utilize the toys in a show setting such as at a zoo or wildlife park. The device is available in at least 3 sizes for parrots and other types of birds and small animals of most sizes and weights.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. Specifically, various materials and sizes are provided, such as for example the size of various pieces/selection of materials/types of fasteners. These are intended to be illustrative and to convey the preferences of the inventor, and are not intended to be limiting or suggest that the use of components of different sizes and shapes are outside the scope of the present invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. An animal toy, comprising:
a longitudinal body element having an upper side and a lower side;
wheels attached to said body element at respective ends thereof for enabling said body element to roll smoothly over a surface;
a pedestal mounted on said upper surface and a perch mounted to said pedestal to enable an animal to grip said perch and thusly move said toy under the control of said animal; and
a detachable training bar attached to a forward end of said body element to enable a user to provide assistance to an animal using said toy.

2. An animal toy as in claim 1, wherein:
said perch is knurled so as to enhance grip between an animal extremity and said perch.

3. An animal toy as in claim 2, wherein:
the number of wheels is at least four wheels, each being rotatably mounted at respective corners of said body.

4. An animal toy as in claim 1, wherein:
each of said body element, pedestal, perch and wheels are made from metal.

5. An animal toy as in claim 5, wherein:
said metal is aluminum.

6. An animal toy as in claim 5, wherein:
said body element, wheels, and training bar comprise at least ⅔ of the total weight of the toy.
